(19) United States
(12) Patent Application Publication
(10) Pub. No.: US 2004/0243583 A1
(43) Pub. Date: Dec. 2, 2004

(54) Systems and methods for providing web services

(76) Inventor: Jesse Dale Olsen, San Diego, CA (US)

Correspondence Address: HEWLETT-PACKARD COMPANY, Intellectual Property Administration, P.O. Box 272400, Fort Collins, CO, 80527-2400, US

(21) Appl. No.: 10/452,687

(22) Filed: Jun. 2, 2003

(51) Int. Cl. G06F 7/00

(52) U.S. Cl. 707/10

(57) ABSTRACT

Methods for providing web services are provided. An exemplary method comprises: prompting an operator for information corresponding to a service; and automatically constructing a web service in response to receiving the information. Systems and computer-readable media also are provided.

### BACKGROUND

A web service is a software application based on the extensible mark-up language (XML) and which is accessible via the Internet. Typically, a web service also includes a public interface that is defined by a web service description language (WSDL). Information contained in the WSDL enables others to access and/or use the web service.

The existence of a web service typically is made known to others by publishing the web service in a directory. One such directory is the universal description, discovery and integration (UDDI). The UDDI includes a list of links corresponding to each of the web services of the directory so that an operator can access a particular web service by locating the web service in the directory and initiating contact via the link.

Note that since web services are constructed in XML, an entity that desires to create a web service typically must employ a programmer with knowledge of XML. As should be understood, employing an XML-literate programmer can be expensive.

### SUMMARY

Systems and methods for providing web services are provided. In this regard, an exemplary method comprises: prompting an operator for information corresponding to a service; and automatically constructing a web service in response to receiving the information.

Another exemplary method comprises: receiving information corresponding to a service of an operator; determining a particular domain of web services with which the information is associated; retrieving information corresponding to a domain template for the particular domain; accessing a web service; making a copy of the web service; prompting the operator for information corresponding to the domain template; and modifying the copy of the web service to include at least some of the information received from the operator and corresponding to the domain template such that a customized web service is constructed.

An exemplary system for providing a web service comprises a generic web service system operative to: communicate with an operator via a communication network; prompt the operator, via the communication network, for information corresponding to a service; receive information corresponding to the service via the communication network; determine a domain of web services to which the service of the operator most closely corresponds; retrieve information corresponding to the domain via the communication network; and automatically constructing a web service in response to receiving the information corresponding to the domain.

Computer-readable media also are provided. An exemplary computer-readable medium has stored thereon instructions executable by a computer for performing method steps, the method steps comprising: receiving information corresponding to a service; and automatically constructing a web service in response to receiving the information.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

Many aspects of the disclosure can be better understood with reference to the following drawings, Note, like reference numerals designate corresponding parts throughout the several views wherein the components in the drawings are not necessarily to scale.

FIG. 1 is a schematic diagram illustrating an embodiment of a web services system.

FIG. 2 is a flowchart depicting functionality of an embodiment of a web services system.

FIG. 3 is a schematic diagram illustrating an embodiment of a computer that can be used to implement a portion of the web services system of FIG. 1

FIG. 4 is a flowchart depicting functionality of the web services hosting system of FIG. 3.

FIG. 5 is a schematic diagram depicting a graphical user interface (GUI) provided by an embodiment of a web services hosting system.

FIG. 6 is a schematic diagram of the GUI of FIG. 5.

FIG. 7 is a schematic diagram depicting a representative web service domain template.

FIG. 8 is a schematic diagram of the GUI of FIGS. 5 and 6.

FIG. 9 is a schematic diagram of another embodiment of a GUI.

FIG. 10 is a schematic diagram of the GUI of FIG. 9.

### DETAILED DESCRIPTION

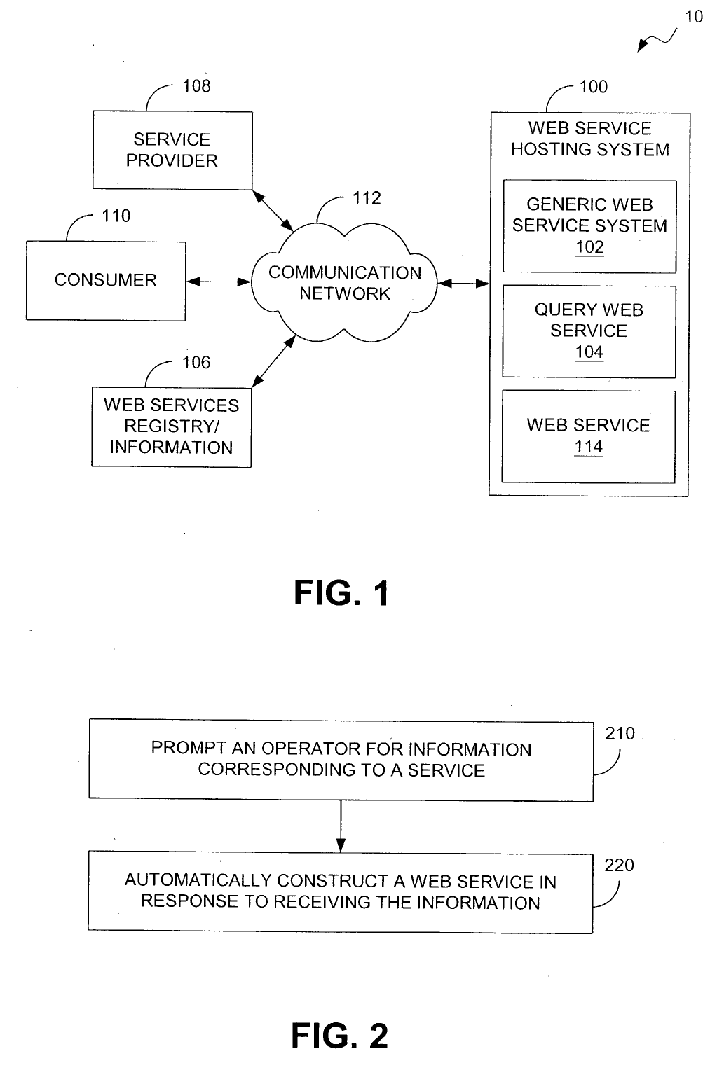

As will be described in detail here, systems and methods facilitate the automatic construction of web services. In some embodiments, this is accomplished by communicating with a generic web service system. By communicating with the generic web service system, a user, e.g., a non-programmer, can provide the system with information and the system can automatically construct a web service based on that information. An embodiment of a generic web service system will now be described with respect to the schematic diagram of FIG. 1.

As shown in FIG. 1, web services system 10 includes a web service hosting system 100 that incorporates a generic web service system 102 and a query web service (QWS) 104. The web service hosting system 100 communicates with web services information 106, such as information provided by the universal description, discovery and integration (UDDI). Web service hosting system 100 also communicates with a service provider 108 and a consumer 110 as will be described in detail later.

Communication between the web service hosting system 100 and other systems/entities is facilitated via a communication network 112. Typically, communication network 112 includes the Internet.

In operation, web service hosting system 100 can be contacted by service provider 108 that intends to offer services via the communication network 112. Specifically, an operator of the service provider contacts the web service hosting system 100 so that a web service can be constructed for informing consumers about the service provider's services. In response to being contacted by the service provider, the web service hosting system 100 enables the service provider to interact with the generic web services system 102 so that a customized web service can be constructed for the service provider.

In order to construct a customized web service for the service provider, generic web services system 102 prompts the service provider for information pertaining to the particular domain of web service that the service provider desires. In this regard, various domains are being established that are specifically suited for use by designated industries. By way of example, a domain may be established for the sale of replacement automobile parts. Once the generic web service system receives information corresponding to a desired domain, the generic web service system can prompt the service provider for additional information until a web service, e.g., web service 114, can be constructed for the service provider. Note that the construction of a web service for the service provider can be accomplished without manually writing programming code, as will be described later. Also note that the generic web service system, query web service and web service of the embodiment of FIG. 1 can be maintained and/or operated separately as their functionality is not necessarily interdependent.

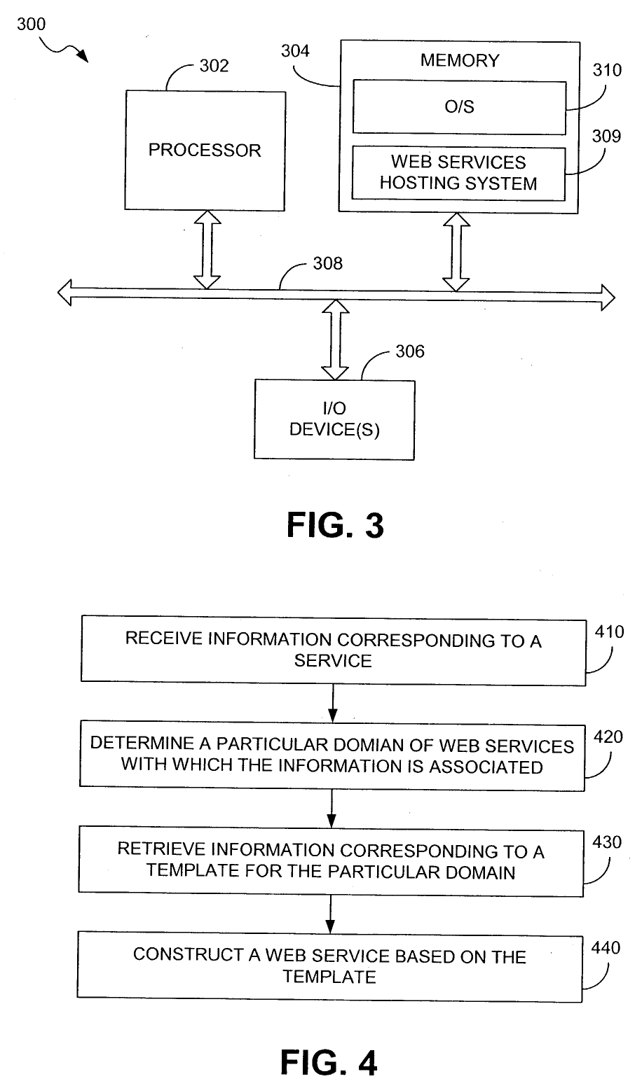

Functionality of an embodiment of a web services system, such as system 10 of FIG. 1, is depicted in the flowchart of FIG. 2. As shown in FIG. 2, the functionality (or method) may be construed as beginning at block 210, where an operator is prompted for information corresponding to a service. Specifically, the information pertains to a service about which the operator intends to provide a web service. In block 220, a web service is automatically constructed in response to receiving the information. Note, at least a portion of the functionality depicted in FIG. 2 can be implemented in hardware, software and/or combinations thereof. By way of example, an embodiment implemented in software can be executed by a processor associated with a computer, such as that depicted in FIG. 3.

In FIG. 3, computer 300 includes a processor 302, memory 304, and one or more input and/or output (I/O) devices 306 (or peripherals) that are communicatively coupled via a local interface 308. The software in memory 304 can include one or more separate programs, each of which comprises an ordered listing of executable instructions for implementing logical functions. In the example of FIG. 3, the software in the memory 304 includes web services hosting system 100, which includes generic web services system 102 and query web service 104, and an operating system (O/S) 310.

When web services hosting system 100 is implemented in software, it should be noted that the web services hosting system can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. Web services hosting system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Functionality of the embodiment of the generic web services system 102 of FIG. 3 will now be described with respect to the flowchart of FIG. 4. As shown in FIG. 4, the functionality (or method) may be construed as beginning at block 410, where information corresponding to a service is received. In block 420, a particular domain of web services is determined. In block 430, information corresponding to a template or standardized format of information associated with the particular domain is retrieved. Then, in block 440, a web service is constructed based on the template. Typically, the template is analyzed by the generic web services system which prompts an operator to provide information corresponding to various fields identified by the template.

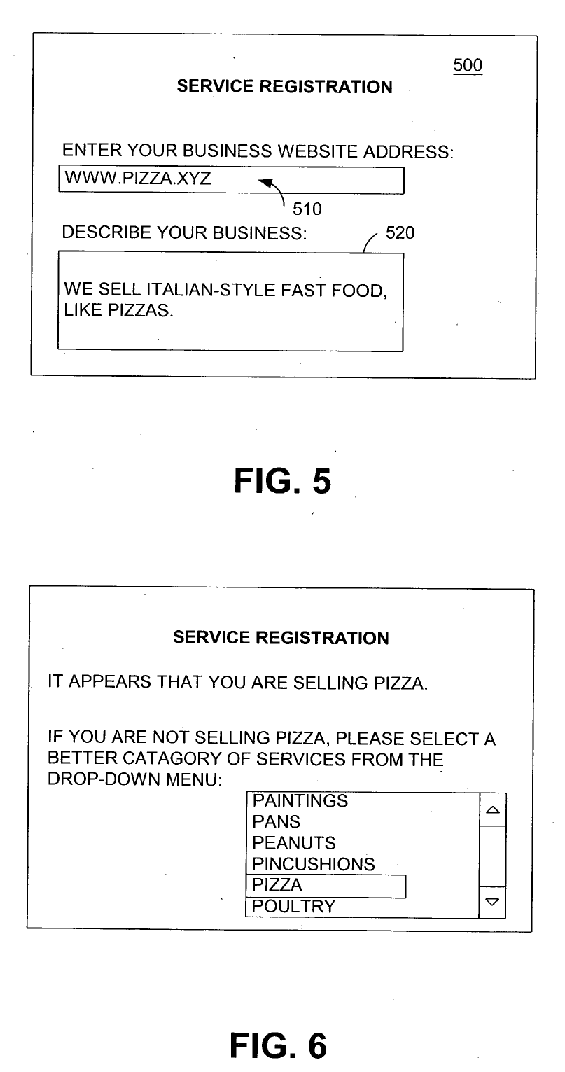

A representative embodiment of a graphical user interface (GUI) that can be provided by a generic web service system for interfacing with an operator is depicted schematically in FIG. 5. Typically, such a GUI is displayed to an operator by a display device, such as a display device associated with a personal computer.

As shown in FIG. 5, the GUI 500 prompts an operator for information 510, such as the Internet address or URL associated with a service. As shown in block 520, the GUI also prompts the operator for a brief description of the type of service that is being provided.

As depicted in FIG. 6, the information provided by the operator is evaluated and an initial determination is made as to which domain of web services most closely corresponds to the information provided. In the example depicted in FIG. 6, the, selected domain corresponds to “pizza,” e.g., at least one of the goods being sold by the operator's service is pizza. Note that in the embodiment of FIG. 6, an operator is provided with the opportunity to select a domain other than that determined by the generic web service system.

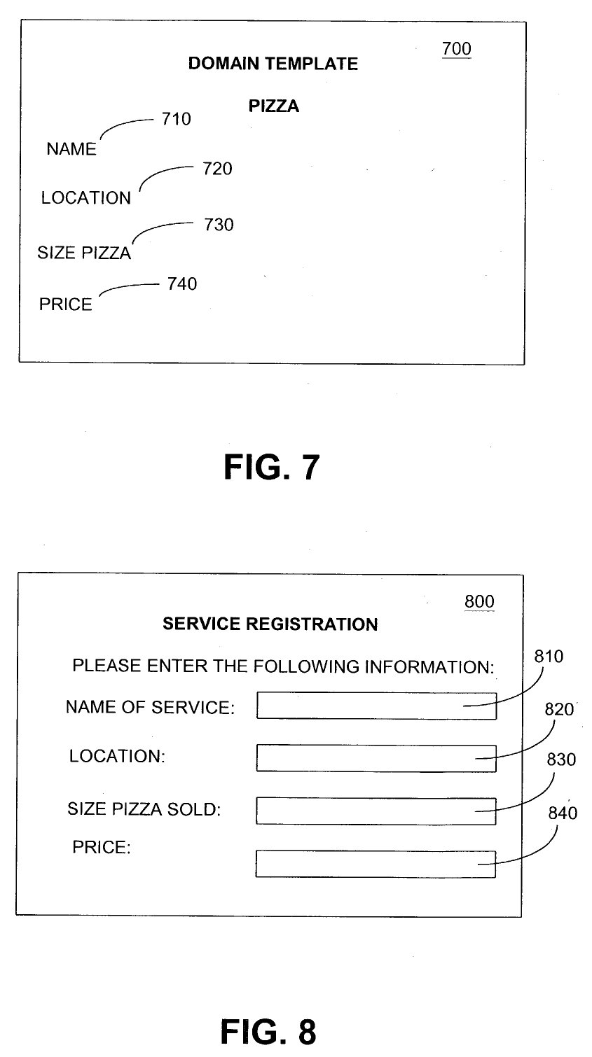

FIG. 7 schematically depicts information associated with the domain template for the selling of pizza. Specifically, the template 700 depicts a standardized format of information that should be included with web services registered as being associated with the “pizza” domain. As shown in FIG. 7, the template 700 includes, for example, information 710 corresponding to the name of the service, information 720 corresponding to the location of the service, information 730 corresponding to the sizes of pizza offered, and information 740 corresponding to the price of each size.

Referring now to FIG. 8, in response to retrieving information corresponding to the appropriate domain template, in this case the pizza domain template 700, the generic web service system prompts the operator to provide information corresponding to each of the fields of the domain template. Thus, as depicted in FIG. 8, the operator is prompted to provide information corresponding to name 810, location 820, size 830 and price 840. Based upon the information received, the generic web service system constructs a web service corresponding to the information provided.

Once the web service has been constructed, the web service can be registered so that consumers can become aware of the existence of the newly-constructed web service. For example, the generic web service system can automatically register the web service with one or more directories of web services, such as the UDDI.

Typically, a consumer becomes aware of a web service when the consumer runs a search or query for a particular service. This is typically accomplished by using a query web service (QWS), an example of which was mentioned briefly before with respect to FIG. 1. Such a QWS typically evaluates one or more directories of web services and then analyzes web services from the directories that includes information meeting the requirements of the query. When web services are identified that meet the requirements of the query, information about the identified web services typically is provided by the QWS to the consumer.

In some embodiments, a query web service, such as query web service 104 FIG. 1, is facilitated by a web site that is provided by a web service hosting system. The web pages of such a web site determine the domain in which the user is interested. The query web service then locates the generic web services listed in the UDDI, for example. Note that the query web service actually does not have to be a web service although being a web service enables the query web service to be registered and consequently discovered in a registry.

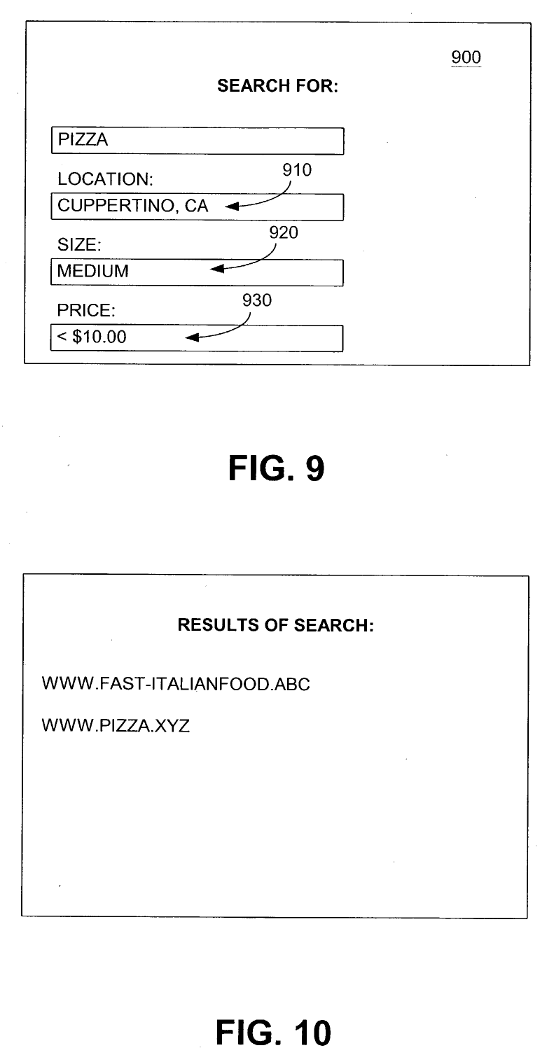

Referring now to FIG. 9, a GUI 900 is depicted that can be used to facilitate a search for a particular service. In this case, the operator has requested information for medium-sized pizzas costing less than $10.00 in the Cupertino, Calif. area. In this example, the GUI 900 of FIG. 9 is an interface for a QWS, which is a web service that searches for specified information. Based upon the information provided by the operator, the QWS associated with GUI 900 initiates contact with a directory of web services, such as the UDDI, to locate web services registered with the relevant domain in this case, pizza.

FIG. 10 schematically depicts results of the search initiated by the QWS referred to in FIG. 9. As shown in FIG. 10, a link 1000 associated with the service described before with respect to FIGS. 5, 6 and 8 is depicted, i.e., www.pizza.xyz. This indicates that the service associated with the www.pizza.xyz link meets the search criteria provided to the QWS.

In some embodiments, a web site of a web service hosting system can be accessed by a user for purchasing a generic web service. By interacting with the web site, the user is issued a pass word and a user name in response to the web service hosting system receiving payment information, e.g., a credit card number. The web service hosting system, e.g., the generic web service system of the web service hosting system, then prompts the user for information pertinent to the domain of web service that the user desires to purchase. Typically, a generic web service system produces a copy of a generic web service that does not include user-specific information. User-specific information is then added to the copy of the generic web service based on the information provided by the user via the web site.

Note that the user could be provided with administrator rights that can allow the user to change information associated with the purchased generic web service. By way of example, this could enable the user to change the price of an item that is offered for sale, such as the price of a pizza that is offered by the web service.

It should be emphasized that the above-described embodiments are merely examples of possible implementations. Many variations and modifications may be made to the above-described embodiments. All such modifications and variations are intended to be included herein within the scope of this disclosure and protected by the following claims.

1. A method for providing a web service comprising:
prompting an operator for information corresponding to a service; and
automatically constructing a web service in response to receiving the information.

2. The method of claim 1, wherein prompting an operator comprises:
providing the operator with a graphical user interface (GUI) that informs the operator that particular information is required.

3. The method of claim 1, wherein automatically constructing a web service comprises:
automatically accessing a web service;
automatically making a copy of the web service; and
automatically modifying the copy of the web service to include at least some of the information received from the operator such that a customized web service is constructed.

4. The method of claim 3, wherein the customized web service is a query web service.

5. The method of claim 1, wherein prompting an operator for information comprises:
determining a domain of web services to which the service of the operator most closely corresponds; and
retrieving information corresponding to the domain determined.

6. The method of claim 5, wherein prompting an operator for information comprises:
prompting the operator for information corresponding to the domain determined; and
using the information to construct the web service for the operator.

7. The method of claim 1, further comprising:
registering the customized web service with a directory of web services.

8. The method of claim 1, further comprising:
receiving information corresponding to a request to purchase a web service from an operator; and
wherein prompting an operator for information is initiated in response to receiving the information corresponding to the request.

9. A system for providing a web service comprising:
a generic web service system operative to:
communicate with an operator via a communication network;
prompt the operator, via the communication network, for information corresponding to a service;
receive information corresponding to the service via the communication network;
determine a domain of web services to which the service of the operator most closely corresponds;
retrieve information corresponding to the domain via the communication network; and
automatically constructing a web service in response to receiving the information corresponding to the domain.

10. The system of claim 9, further comprising:
a memory communicatively coupled to the generic web service system; and
wherein, in automatically constructing a web service, the generic web service system is operative to:
automatically access a first web service;
automatically make a copy of the first web service; and
automatically modify the copy of the first web service to include at least some of the information received from the operator such that the web service constructed is customized for the operator.

11. The system of claim 9, wherein the generic web service system comprises means for communicating with the communication network.

12. The system of claim 9, further comprising:
a query web service operative to:
communicate with the operator via the communication network;
receive information from the operator corresponding to a query; and
search a directory of web services for web services corresponding to the query.

13. The system of claim 9, wherein the generic web service has constructed a second web service customized for a first operator and a third web service customized for a second operator, the second web service being different from the third web service, the second web service and the third web service each being formed as a modified copy of the first web service.

14. A computer-readable medium having stored thereon instructions executable by a computer for performing method steps, said method steps comprising:
receiving information corresponding to a service; and
automatically constructing a web service in response to receiving the information.

15. The computer-readable medium of claim 14, wherein automatically constructing a web service comprises:
automatically accessing a web service;
automatically making a copy of the web service; and
automatically modifying the copy of the web service to include at least some of the information received from the operator such that a customized web service is constructed.

16. The computer-readable medium of claim 14, wherein automatically constructing a web service comprises:
determining a domain of web services to which the service of the operator most closely corresponds; and
retrieving information corresponding to the domain determined.

17. The computer-readable medium of claim 14, further comprising:
registering the customized web service with a directory of web services.

18. The computer-readable medium of claim 14, further comprising:
receiving information corresponding to a request to purchase a web service from an operator; and
wherein prompting an operator for information is initiated in response to receiving the information corresponding to the request.

19. A method for providing a web service comprising:
receiving information corresponding to a service of an operator;
determining a particular domain of web services with which the information is associated;
retrieving information corresponding to a domain template for the particular domain;
accessing a web service;
making a copy of the web service;
prompting the operator for information corresponding to the domain template; and
modifying the copy of the web service to include at least some of the information received from the operator and corresponding to the domain template such that a customized web service is constructed.

20. The method of claim 19, further comprising:
registering the customized web service with a directory of web services.
